(19) United States
(12) Patent Application Publication
(10) Pub. No.: US 2003/0213655 A1
(43) Pub. Date: Nov. 20, 2003

(54) Tower for supporting an elevator thereon

(76) Inventor: Andre St-Germain, St-Bonaventure (CA)

Correspondence Address: Andre ST-GERMAIN, c/o PROTECTIONS EQUINOX INT'L INC., Suite 224, 4480, Cote-de-Liesse, Montreal, QC, H4N 2R1, CA

(21) Appl. No.: 10/440,226

(22) Filed: May 19, 2003

Related U.S. Application Data
(60) Provisional application No. 60/381,370, filed on May 20, 2002.

(51) Int. Cl. B66B 7/02

(52) U.S. Cl. 187/406; 57/30

(57) ABSTRACT

A tower for selectively supporting an elevator thereon includes an elongated structure that slidably supports the elevator therealong. The elongated structure defines a structure axis and includes at least two generally opposed first and second longitudinal structure sidewalls. Generally elongated first and second elevator retaining guides releasably secure to the first and second structure sidewalls, respectively, for guiding and retaining the elevator along the elongated structure. The first and second retaining guides extend generally radially outwardly from the elongated structure.

### CROSS-REFERENCE TO RELATED APPLICATION

This application is related to U.S. Provisional Application for Patent Serial No. 60/381,370 filed on May 20, 2002.

### FIELD OF THE INVENTION

The present invention relates to towers, and more particularly to a tower or mast for selectively supporting an elevator, platform or the like thereon.

### BACKGROUND OF THE INVENTION

Towers or masts are well known in the construction art such as in scaffoldings and the like as disclosed in U.S. Pat. No. 5,159,993 granted to St-Germain on Nov. 3, 1992; U.S. Pat. No. 5,746,290 granted to St-Germain et al. on May 5, 1998 or U.S. Pat. No. 6,311,800 granted to St-Germain et al. on Nov. 6, 2001. Typical towers of the industry are either triangular-, rectangular- or square-shaped and are usually used in pairs to support a platform in-between. Accordingly, these towers need not to be very rigid and resistant to buckling and/or bending within a plane generally intersecting the two towers of the pair. A single of these tower cannot be used as a support structure for a raising platform or the like, especially for multi-level applications of more than 4 or 5 levels. Often, these towers are not symmetrical and the tower longitudinal sections need to be properly aligned to each other during installation assembly which increases the installation set-up time.

Towers are made to support a specific type of platform, elevator or sleeve there along. It is therefore not possible to interchange neither the type nor the quantity of platforms/elevators simultaneously supported by one same adaptable or customizable tower. For different applications, one needs to change the entire scaffold set-up accordingly, which is time consuming and not too practical in terms of equipment rental and/or warehousing.

Consequently, there is a need for an improved tower for supporting at least one or two independent elevators/platforms thereon and with relatively high load capacity, especially for use in the construction of small to medium size buildings.

### SUMMARY OF THE INVENTION

It is therefore a general object of the present invention to provide an improved tower for supporting an elevator thereon.

An advantage of the present invention is that the tower obviates the above noted disadvantages.

Another advantage of the present invention is that the tower is modular and can be easily assembled (and disassembled) by an operator using standard available tools.

A further advantage of the present invention is that the tower can, depending of the operator needs, be used to slidably support either one large platform or two simultaneous and independent smaller platforms/elevators.

Yet another advantage of the present invention is that the tower has a relatively high load capability.

Another advantage of the present invention is that the tower can be easily anchored to an adjacent structure in order to improve its overall structural rigidity especially for relatively high applications, without affecting displacement of raising platforms or elevators along the tower.

Still a further advantage of the present invention is that the tower is fully symmetrical with all sidewalls identical to each other, with no specific required installation orientation.

Yet a further advantage of the present invention is that the tower can be selectively used in different successive configuration while remaining at the same location on the site.

According to an aspect of the present invention, there is provided a tower for selectively supporting an elevator thereon, the tower comprises: an elongated structure for slidably supporting the elevator therealong, the elongated structure defining a structure axis, the elongated structure including at least two generally opposed first and second longitudinal structure sidewalls; generally elongated first and second elevator retaining guides releasably securing to the first and second structure sidewalls, respectively, for guiding and retaining the elevator along the elongated structure, the first and second retaining guides extending generally radially outwardly from the elongated structure.

In one embodiment, each of the first and second retaining guides includes first and second longitudinal guide walls, the first and second guide walls being in an angled relationship relative to one another, the first guide wall being attachable to the elongated structure, the second guide wall being for selective engagement with the elevator.

Typically, the first and second guide walls being in a generally perpendicular relationship relative to one another so as to have the second guide wall extending generally radially outwardly from the elongated structure.

Typically, each of the first and second retaining guides includes an attachment means for releasably attaching the first guide wall to a respective one of the first and second structure sidewalls.

Typically, the second guide wall includes a generally planar second wall surface for being in sliding engagement with the elevator.

In one embodiment, each of the first and second structure sidewalls has first and second longitudinal edges, the elongated structure including a third longitudinal structure sidewall, the third structure sidewall extending between the first longitudinal edges of the first and second structure sidewalls; the tower further including a generally elongated track member releasably securing to the third structure sidewall for selective tracking engagement with the elevator therealong, the track member extending generally radially outwardly from the elongated structure.

Typically, the track member includes a generally elongated support plate, the support plate defining generally opposed first and second longitudinal plate main surfaces, the first plate main surface being releasably and securingly engageable with the third structure sidewall, the track member further including a plurality of shelves mounted thereon, the shelves extending generally transversely and outwardly from the second plate main surface for selective tracking engagement with the elevator thereon, the shelves being generally longitudinally equally spaced apart from each other.

In one embodiment, each of the first and second structure sidewalls has generally opposed first and second longitudinal edges, the elongated structure including a third longitudinal structure sidewall, the third structure sidewall extending between the first longitudinal edges of the first and second structure sidewalls; the third structure sidewall including a plurality rungs extending generally transversely thereon for selective tracking engagement with the elevator thereon, the rungs being generally longitudinally equally spaced apart from each other.

Typically, the elongated structure includes a fourth longitudinal structure sidewall, the fourth structure sidewall extending between the second longitudinal edges of the first and second structure sidewalls; the fourth structure sidewall including a plurality rungs extending generally transversely thereon for selective tracking engagement with an elevator thereon, the rungs being generally longitudinally equally spaced apart from each other.

Typically, each of the first and second structure sidewalls includes a plurality rungs extending generally transversely thereon, the rungs being generally longitudinally equally spaced apart from each other and releasably and securingly supporting respective of the first and second retaining guides thereon.

Typically, the elongated structure has a generally square-shaped transverse cross-section, the first, second, third and fourth structure sidewalls being substantially identical to each other so that the first and second retaining guides are attachable to any two opposed ones of the structure sidewalls. The elongated structure includes a plurality of longitudinal structure sections, the structure sections being releasably attachable to one another into an end-to-end configuration along the structure axis.

Typically, each of the rungs is supported by a pair of braces extending outwardly and downwardly from the rung, the braces of each of the pairs extending away from each other in a direction leading away from the rung so as to form a braced framing with splayed legs therewith.

Typically, each of the structure sections includes a first internal cross-brace, the first cross-brace extending downwardly and diagonally across the structure section so as to form a longitudinal sway bracing thereof. The square-shaped cross-section defines first and second diagonals thereof, the first and second diagonals being generally in a perpendicular relationship relative to one another, the first internal cross-brace extending along the first diagonal, each of the structure sections includes a second internal cross-brace, the second cross-brace extending downwardly and diagonally across the structure section along the second diagonal.

In one embodiment, the elongated structure defines a first plane of symmetry, the first plane of symmetry including the structure axis and being located generally halfway between the first and second structure sidewalls, the first plane of symmetry dividing the elongated structure into first and second longitudinal structure half portions, the first and second structure half portions including the first and second structure sidewalls respectively and being substantially a mirror image of one another.

Typically, each of the first and second structure sidewalls has generally opposed first and second longitudinal edges, the elongated structure including generally opposed third and fourth longitudinal structure sidewalls, the third and fourth structure sidewalls extending between the first longitudinal edges and the second longitudinal edges of the first and second structure sidewalls, respectively.

Typically, the first and second structure sidewalls are generally parallel to one another and the third and fourth structure sidewalls are generally parallel to one another.

In one embodiment, the elevator is a first elevator and the first and second structure sidewalls are in a generally parallel relationship relative to one another, each of the first and second structure sidewalls having generally opposed first and second longitudinal edges, the elongated structure including generally opposed third and fourth longitudinal structure sidewalls, the third and fourth structure sidewalls extending between the first longitudinal edges and the second longitudinal edges of the first and second structure sidewalls, respectively; the tower further including generally elongated third and fourth elevator retaining guides releasably securing to the first and second structure sidewalls, respectively, for guiding and retaining a second elevator along the elongated structure, the third and fourth retaining guides extending generally radially outwardly from the elongated structure, the third and fourth retaining guides being spaced form the first and second retaining guides, respectively, so as to allow the first and second elevators to selectively face each other during independent displacement along the tower adjacent the third and fourth structure sidewalls, respectively.

Typically, the tower further includes generally elongated first and second track members releasably securing to the third and fourth structure sidewalls, respectively, for selective tracking engagement with the first and second elevators therealong, respectively, the first and second track members extending generally radially outwardly from the elongated structure.

Typically, each of the third and fourth structure sidewalls includes a plurality rungs extending generally transversely thereon for selective tracking engagement with the first and second elevators thereon, respectively, the rungs being generally longitudinally equally spaced apart from each other.

Typically, the elongated structure has a generally rectangle-shaped transverse cross-section, the elongated structure defining two generally orthogonal planes intersecting each other along the structure axis, each of the two orthogonal planes being generally located half-way between respective ones of opposed structure sidewalls such that the tower is generally symmetrical about each of the two orthogonal planes.

Typically, the elongated structure has a generally square-shaped transverse cross-section, the first, second, third and fourth structure sidewalls being substantially identical to each other so that the retaining guides are attachable to any two opposed ones of the structure sidewalls while the rungs of the other two of the structure sidewalls are for selective tracking engagement with a respective one of the elevators.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which like reference characters indicate like elements throughout, wherein:

FIG. 1 is a partially broken exploded top perspective view of an embodiment of a tower in accordance with the present invention for supporting two independent elevators thereon;

FIG. 2 is a top perspective view of the embodiment of FIG. 1, showing the assembled tower with the elevators mounted thereon;

FIG. 3 is a partially broken enlarged top plan view of the embodiment of FIG. 1 with sections taken out, showing the tower independently supporting the two elevators that clear a wall anchor securing the tower to an adjacent structure;

FIG. 4 is a perspective view of a tower section of the embodiment of FIG. 1 with sections taken out, showing the internal longitudinal sway bracings; and

FIG. 5 is a view similar to FIG. 2, showing the assembled tower with one elevator/platform mounted thereon.

### DETAILED DESCRIPTION OF THE PREFERRED EMBODIMENTS

With reference to the annexed drawings the preferred embodiments of the present invention will be herein described for indicative purpose and by no means as of limitation.

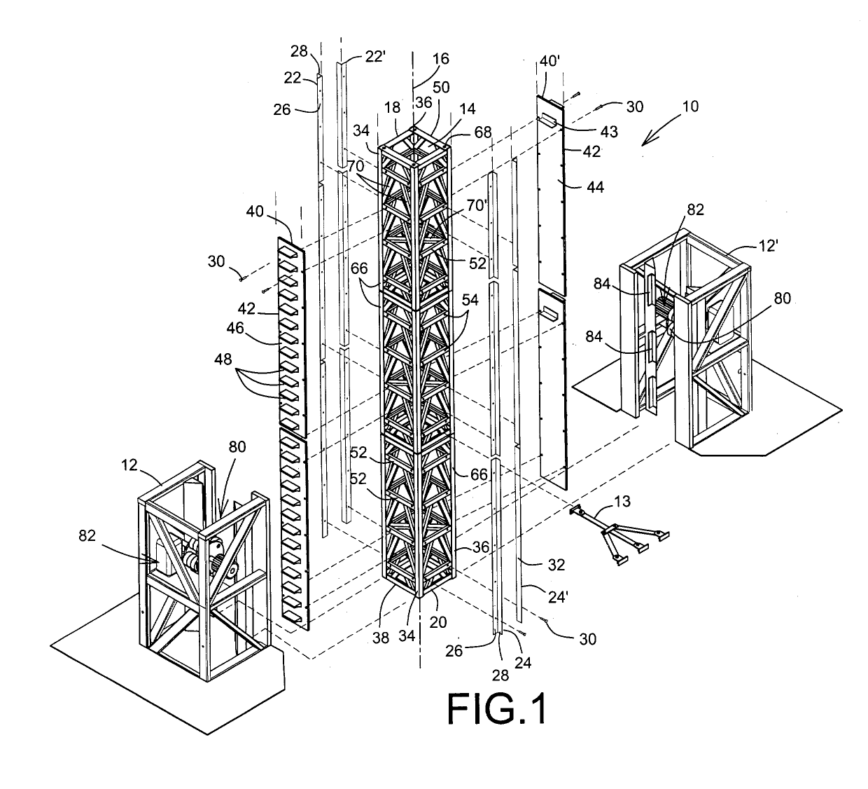

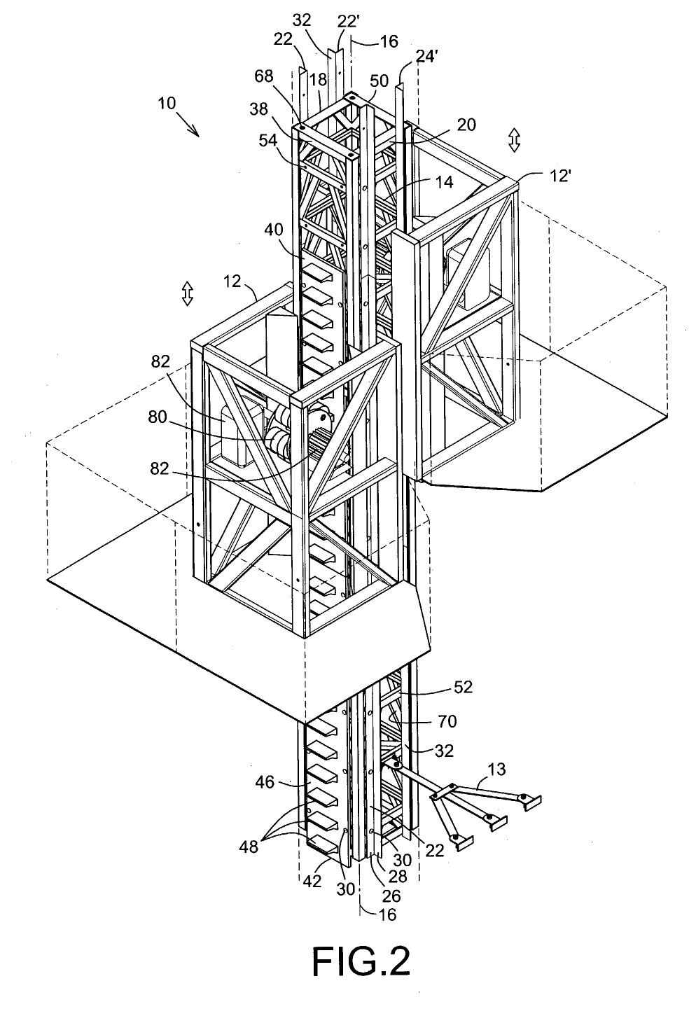

Referring to FIGS. 1 and 2, there is shown an embodiment of a tower 10 in accordance with the present invention for selectively supporting an elevator 12 thereon. The tower includes an elongated structure 14 for slidably supporting the elevator 12 therealong that at least partially covers, embraces or surrounds the tower 10. The elongated structure 14 defines a structure axis 16 and includes at least two generally opposed first and second longitudinal structure sidewalls 18, 20. The tower further includes generally elongated first and second elevator retaining guides 22, 24 for guiding and retaining the elevator 12 along the elongated structure 14. The first and second elevator retaining guides 22, 24 are releasably secured to the first and second structure sidewalls 18, 20, respectively, and extend generally radially outwardly from the elongated structure 14.

Typically, each retaining guide 22, 24 includes first and second longitudinal guide walls 26, 28 that are connected to each other in an angled, preferably perpendicular, relationship relative to one another. The first guide wall 26 is attachable to the elongated structure 14 and extends in a generally parallel relationship relative thereto. The second guide wall 28 is for selective sliding engagement with the elevator 12 and extends generally radially outwardly from the elongated structure 14.

Typically, each retaining guide 22, 24 includes an attachment means, such as conventional bolts 30 or the like fasteners, for releasably attaching the first guide wall 26 to the respective structure sidewall 18, 20. The second guide wall 28 includes a generally planar second wall surface 32 that slidably engages the elevator 12.

Each one of the first and second structure sidewalls 18, 20 has first and second longitudinal edges 34, 36. The elongated structure 14 includes a third longitudinal structure sidewall 38 that extends, typically linearly, between the first longitudinal edges 34 of the first and second structure sidewalls 18, 20. The tower 10 further includes a generally elongated track member 40 (or teeth rack as in the type shown in U.S. Pat. No. 5,636,705 granted to the applicant on Jun. 10, 1997 and in U.S. Pat. No. 6,311,800 granted to the applicant et al. on Nov. 6, 2001) that releasably secures to the third structure sidewall 38 for selective tracking engagement with the elevator 12 therealong. The track member 40 extends generally radially outwardly from the elongated structure 14.

Typically, the track member 40 includes a generally elongated support plate 42 that defines generally opposed first and second longitudinal plate main surfaces 44, 46. The first plate main surface 44 releasably and abuttingly engages the third structure sidewall 38. The track member 40 further includes a plurality of shelves 48 mounted thereon and extending generally transversely and outwardly from the second plate main surface 46 for selective tracking engagement with the elevator 12 thereon; the shelves 48 are generally longitudinally equally spaced apart from each other along the support plate 42.

Furthermore, the elongated structure 14 includes a fourth longitudinal structure sidewall 50 that extends, typically linearly, between the second longitudinal edges 36 of the first and second structure sidewalls 18, 20.

Typically, the four structure sidewalls 18, 20, 38, 50 includes a plurality rungs 52 that extend generally transversely, preferably horizontally, thereon and that are generally longitudinally equally spaced apart from each other along their respective structure sidewall 18, 20, 38, 50. The rungs 52 are for selective tracking engagement with an elevator 12 thereon. The rungs 52 are provided with attachment holes 54 for the selective attachment of either a respective elevator retaining guide 22, 24 or a track member 40 thereto using bolts 30 or the like.

In order to help aligning and installing the support plate 42 onto the respective structure sidewall 38, 50, at least one support hook 43 extends generally outwardly from the first plate main surface 44 at a proper location thereon to abut a corresponding rung 52 prior to its attachment using the bolts 30.

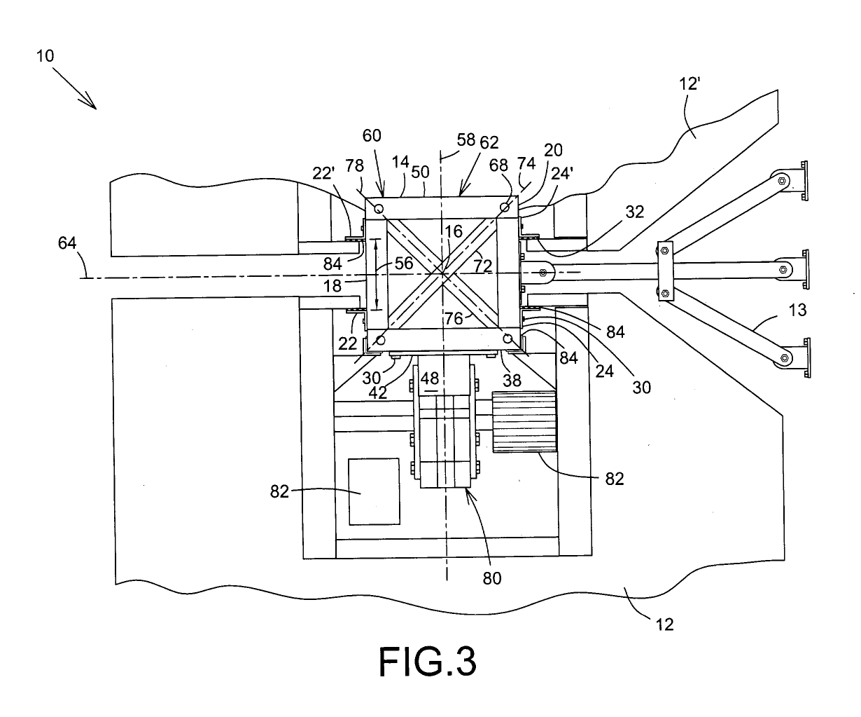

Typically, generally elongated third and fourth elevator retaining guides 22′, 24′ releasably secure to the first and second structure sidewalls 18, 20, respectively, for guiding and retaining a second elevator 12′ along the elongated structure 14. The third and fourth retaining guides 22′, 24′ extend generally radially outwardly from the elongated structure 14, and are spaced form the first and second retaining guides 22, 24, respectively, by a distance 56 indicated in FIG. 3. The distance 56 is generally sufficient to allow the first and second elevators 12, 12′ to selectively face each other and be in a face-to-face relationship relative to one another during their independent displacement along the tower 10, adjacent the third and fourth structure sidewalls 38, 50, respectively. Furthermore, the distance 56 allows for wall anchors 13 that secures the tower 10 to an adjacent building wall or the like (not shown) to freely access the tower 10 without restricting the displacement of the elevators 12, 12′ there along, as shown in FIGS. 1, 2, 3 and 5.

Accordingly, a second track member 40′ releasably and selectively secures to the fourth structure sidewall 50 for selective tracking engagement with the second elevator 12′ therealong.

Referring more specifically to FIG. 3, the elongated structure 14 defines a first plane of symmetry 58 that includes the structure axis 16. The first symmetry plane 58 is located generally halfway between the first and second structure sidewalls 18, 20 and divides the elongated structure 14 into first and second longitudinal structure half portions 60, 62 that include the first and second structure sidewalls 18, 20 and that are substantially a mirror image of one another.

Typically, the first and second structure sidewalls 18, 20 are generally parallel to one another, and the third and fourth structure sidewalls 38, 50 are also generally parallel to one another.

Accordingly, the elongated structure 14 has a generally rectangular-shaped transverse cross-section with a second plane of symmetry 64 is generally perpendicular to and intersect the first symmetry plane 58 along the structure axis 16. Preferably, the elongated structure 14 has a square-shaped transverse cross-section with the first, second, third and fourth structure sidewalls 18, 20, 38, 50 being substantially identical to each other.

Consequently, the first and second retaining guides 22, 24 are typically attachable to any pair of opposed ones of the structure sidewalls 18, 20, 38, 50, without having to worry about or pay attention to the orientation of the tower structure 14.

Typically, the elongated structure 14 includes a plurality of longitudinal structure sections 66 that are releasably attached to one another into an end-to-end configuration along the structure axis 16, using conventional bolts (not shown) or the like fasteners through corresponding end holes 68 located at each longitudinal ends thereof, preferably at the corners thereof.

For increased rigidity of the tower section 66 and increased load bearing capacity of each rung 52, the latter is typically supported by a pair of rung braces 70 that extend outwardly and downwardly therefrom. Each rung brace 70 of each pair extends away from the other one 70 in a direction leading away from the corresponding rung 52 so as to form a braced framing with splayed legs therewith.

For increased resistance to buckling and bending, each structure section 66 includes a first internal cross-brace 72 that extends generally downwardly and diagonally there across along a first cross-sectional diagonal direction 74 so as to form a longitudinal sway bracing thereof.

Preferably, each structure section 66 further includes a second internal cross-brace 76 that similarly extends downwardly and diagonally there across along a second cross-sectional diagonal direction 78 generally intersecting the first diagonal direction 74 along the structure axis 16.

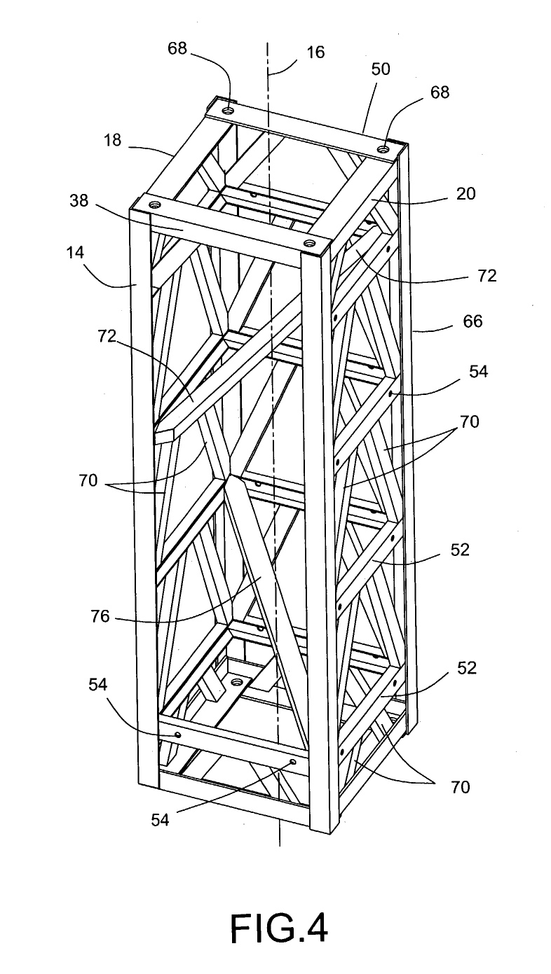

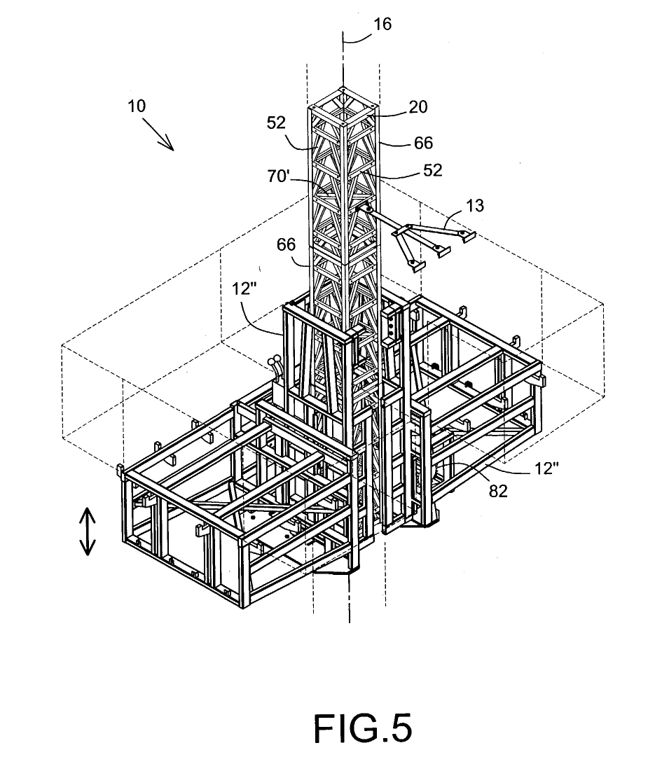

Preferably, the first and second cross-braces 72, 76 extend between two successive pairs of adjacent layers of rungs 52, as shown in FIG. 4. Furthermore, horizontal cross-braces 70′ are also used, typically, as shown in FIGS. 1 and 5.

Referring to FIG. 5, there is shown the tower 10 being used with a single platform 12″ that releasably, directly and selectively secures to the rungs 52, in a different application.

The elevators 12, 12′, 12″ typically include their own different and independent actuating mechanisms 80, including corresponding power unit 82, for their respective guided up-and-down movement along the tower 10, as exemplified in U.S. Pat. No. 5,159,993 granted to St-Germain on Nov. 3, 1992; U.S. Pat. No. 5,746,290 granted to St-Germain et al. on May 5, 1998 or U.S. Pat. No. 6,311,800 granted to St-Germain et al. on Nov. 6, 2001.

As shown in FIGS. 1 and 3, the elevators 12, 12′ includes a plurality of conventional guiding bushings or low friction surface pads 84 (see U.S. Pat. No. 5,368,125 granted to St-Germain on Nov. 29, 1994; and U.S. Pat. No. 5,746,290 granted to St-Germain et al. on May 5, 1998), preferably uniformly distributed therein, to allow the elevators 12, 12′ to slidably engage the different surfaces of the tower 10, including the second wall surface 32 of the retaining guides 22, 22′, 24, 24′.

For the assembly, the lowest retaining guides 22, 22′, 24, 24′ and track members 40, 40′ are installed on the elongated structure 14 with the elevator 12, 12′ substantially in place there around. Subsequent upper retaining guides 22, 22′, 24, 24′ and track members 40, 40′ are installed by operators (not shown) climbing along the tower 10 on the elevators 12, 12′. Although the above description refers to a generally rectangular-shaped cross-section of the tower structure 14, it would be obvious to one having ordinary skill in the art that any polygonal-shaped cross-section could be used without departing from the scope of the present invention, as long as there are at least two generally opposed sidewalls.

Although the present tower for supporting an elevator thereon has been described with a certain degree of particularity it is to be understood that the disclosure has been made by way of example only and that the present invention is not limited to the features of the embodiments described and illustrated herein, but includes all variations and modifications within the scope and spirit of the invention as hereinafter claimed.

I claim:

1. A tower for selectively supporting an elevator thereon, said tower comprising:
an elongated structure for slidably supporting the elevator therealong, said elongated structure defining a structure axis, said elongated structure including at least two generally opposed first and second longitudinal structure sidewalls;
generally elongated first and second elevator retaining guides releasably securing to said first and second structure sidewalls, respectively, for guiding and retaining the elevator along said elongated structure, said first and second retaining guides extending generally radially outwardly from said elongated structure.

2. The tower of claim 1, wherein each of said first and second retaining guides includes first and second longitudinal guide walls, said first and second guide walls being in an angled relationship relative to one another, said first guide wall being attachable to said elongated structure, said second guide wall being for selective engagement with the elevator.

3. The tower of claim 2, wherein said first and second guide walls being in a generally perpendicular relationship relative to one another so as to have said second guide wall extending generally radially outwardly from said elongated structure.

4. The tower of claim 3, wherein each of said first and second retaining guides includes an attachment means for releasably attaching said first guide wall to a respective one of said first and second structure sidewalls.

5. The tower of claim 4, wherein said second guide wall includes a generally planar second wall surface for being in sliding engagement with the elevator.

6. The tower of claim 1, wherein each of said first and second structure sidewalls has first and second longitudinal edges, said elongated structure including a third longitudinal structure sidewall, said third structure sidewall extending between said first longitudinal edges of said first and second structure sidewalls;
said tower further including a generally elongated track member releasably securing to said third structure sidewall for selective tracking engagement with the elevator therealong, said track member extending generally radially outwardly from said elongated structure.

7. The tower of claim 6, wherein said track member includes a generally elongated support plate, said support plate defining generally opposed first and second longitudinal plate main surfaces, said first plate main surface being releasably and securingly engageable with said third structure sidewall, said track member further including a plurality of shelves mounted thereon, said shelves extending generally transversely and outwardly from said second plate main surface for selective tracking engagement with the elevator thereon, said shelves being generally longitudinally equally spaced apart from each other.

8. The tower of claim 1, wherein each of said first and second structure sidewalls has generally opposed first and second longitudinal edges, said elongated structure including a third longitudinal structure sidewall, said third structure sidewall extending between said first longitudinal edges of said first and second structure sidewalls;
said third structure sidewall including a plurality rungs extending generally transversely thereon for selective tracking engagement with the elevator thereon, said rungs being generally longitudinally equally spaced apart from each other.

9. The tower of claim 8, wherein said elongated structure includes a fourth longitudinal structure sidewall, said fourth structure sidewall extending between said second longitudinal edges of said first and second structure sidewalls;
said fourth structure sidewall including a plurality rungs extending generally transversely thereon for selective tracking engagement with an elevator thereon, said rungs being generally longitudinally equally spaced apart from each other.

10. The tower of claim 9, wherein each of said first and second structure sidewalls includes a plurality rungs extending generally transversely thereon, said rungs being generally longitudinally equally spaced apart from each other and releasably and securingly supporting respective of said first and second retaining guides thereon.

11. The tower of claim 10, wherein said elongated structure has a generally square-shaped transverse cross-section, said first, second, third and fourth structure sidewalls being substantially identical to each other so that said first and second retaining guides are attachable to any two opposed ones of said structure sidewalls.

12. The tower of claim 11, wherein said elongated structure includes a plurality of longitudinal structure sections, said structure sections being releasably attachable to one another into an end-to-end configuration along said structure axis.

13. The tower of claim 12, wherein each of said rungs is supported by a pair of braces extending outwardly and downwardly from said rung, said braces of each of said pairs extending away from each other in a direction leading away from said rung so as to form a braced framing with splayed legs therewith.

14. The tower of claim 13, wherein each of said structure sections includes a first internal cross-brace, said first cross-brace extending downwardly and diagonally across said structure section so as to form a longitudinal sway bracing thereof.

15. The tower of claim 14, wherein said square-shaped cross-section defines first and second diagonals thereof, said first and second diagonals being generally in a perpendicular relationship relative to one another, said first internal cross-brace extending along said first diagonal, each of said structure sections includes a second internal cross-brace, said second cross-brace extending downwardly and diagonally across said structure section along said second diagonal.

16. The tower of claim 1, wherein said elongated structure defines a first plane of symmetry, said first plane of symmetry including said structure axis and being located generally halfway between said first and second structure sidewalls, said first plane of symmetry dividing said elongated structure into first and second longitudinal structure half portions, said first and second structure half portions including said first and second structure sidewalls respectively and being substantially a mirror image of one another.

17. The tower of claim 16, wherein each of said first and second structure sidewalls has generally opposed first and second longitudinal edges, said elongated structure including generally opposed third and fourth longitudinal structure sidewalls, said third and fourth structure sidewalls extending between said first longitudinal edges and said second longitudinal edges of said first and second structure sidewalls, respectively.

18. The tower of claim 17, wherein said first and second structure sidewalls are generally parallel to one another and said third and fourth structure sidewalls are generally parallel to one another.

19. The tower of claim 18, wherein said elongated structure has a generally square-shaped transverse cross-section, said first, second, third and fourth structure sidewalls being substantially identical to each other so that said first and second retaining guides are attachable to any two opposed ones of said structure sidewalls.

20. The tower of claim 17, wherein said elongated structure defines a second plane of symmetry, said first and second planes of symmetry being generally perpendicular to each other and intersecting each other along said structure axis.

21. The tower of claim 1, wherein the elevator is a first elevator and said first and second structure sidewalls are in a generally parallel relationship relative to one another, each of said first and second structure sidewalls having generally opposed first and second longitudinal edges, said elongated structure including generally opposed third and fourth longitudinal structure sidewalls, said third and fourth structure sidewalls extending between said first longitudinal edges and said second longitudinal edges of said first and second structure sidewalls, respectively;
said tower further including generally elongated third and fourth elevator retaining guides releasably securing to said first and second structure sidewalls, respectively, for guiding and retaining a second elevator along said elongated structure, said third and fourth retaining guides extending generally radially outwardly from said elongated structure, said third and fourth retaining guides being spaced form said first and second retaining guides, respectively, so as to allow the first and second elevators to selectively face each other during independent displacement along the tower adjacent said third and fourth structure sidewalls, respectively.

22. The tower of claim 21, further including generally elongated first and second track members releasably securing to said third and fourth structure sidewalls, respectively, for selective tracking engagement with the first and second elevators therealong, respectively, said first and second track members extending generally radially outwardly from said elongated structure.

23. The tower of claim 21, wherein each of said third and fourth structure sidewalls includes a plurality rungs extending generally transversely thereon for selective tracking engagement with the first and second elevators thereon, respectively, said rungs being generally longitudinally equally spaced apart from each other.

24. The tower of claim 23, wherein said elongated structure has a generally rectangle-shaped transverse cross-section, said elongated structure defining two generally orthogonal planes intersecting each other along said structure axis, each of said two orthogonal planes being generally located half-way between respective ones of opposed structure sidewalls such that said tower is generally symmetrical about each of said two orthogonal planes.

25. The tower of claim 24, wherein each of said first and second structure sidewalls includes a plurality rungs extending generally transversely thereon, said rungs being generally longitudinally equally spaced apart from each other and releasably and securingly supporting respective of said first, second, third and fourth retaining guides thereon.

26. The tower of claim 25, wherein said elongated structure has a generally square-shaped transverse cross-section, said first, second, third and fourth structure sidewalls being substantially identical to each other so that said retaining guides are attachable to any two opposed ones of said structure sidewalls while said rungs of the other two of said structure sidewalls are for selective tracking engagement with a respective one of the elevators.
